(19) United States
(12) Patent Application Publication
(10) Pub. No.: US 2002/0022475 A1
(43) Pub. Date: Feb. 21, 2002

(54) Information delivery system and information delivery method four

(76) Inventors: Kiyoshi Tsuneki, Tokyo (JP); Takashi Yamazaki, Tokyo (JP)

Correspondence Address: YOUNG & THOMPSON, 745 SOUTH 23RD STREET 2ND FLOOR, ARLINGTON, VA, 22202

(21) Appl. No.: 09/917,758

(22) Filed: Jul. 31, 2001

(30) Foreign Application Priority Data
Aug. 13, 2000 (JP) 2000-264549

(51) Int. Cl. H04M 11/10

(52) U.S. Cl. 455/412; 455/414; 455/515

(57) ABSTRACT

An information delivery system and information delivery method are provided that avoid any increase in radio traffic and meet the requirements of users by delivering information to a user terminal only when available radio resources are present. An available radio resources determination section determines whether or not available radio resources are present in each zone. When an information delivery section acquires information about presence of available radio resources in zones from the available radio resources determination section, it delivers information stored in an information database to user terminals located in the zones in which the available radio resources have been detected. Thus it is able to deliver information to a user terminal without causing any increase in the radio traffic.

### BACKGROUND OF THE INVENTION

1. Field of the Invention

The present invention relates to an information delivery system for delivering information to a portable mobile communication terminal using radio circuits and particularly to an information delivery system and information delivery method that effectively utilize the radio resources.

2. Description of the Related Art

Conventionally, when contents are acquired using a mobile communication terminal as represented by PHS (Personal Handyphone System), PDC (Personal Digital Cellular), and the like, a user firstly accesses a contents provider (i.e. a contents delivery center) via a base station and then requests the delivery of contents by indicating the desired contents. At this time, as the contents to be delivered are stored by the contents provider in a multilevel structure, because the contents are gradually narrowed down by the user selecting the selection options displayed on the display portion of the terminal until ultimately the desired contents can be indicated, indicating the desired contents requires a considerable amount of time.

Moreover, because the telephone is in an engaged state for the period of time the series of tasks required to perform the above contents acquisition are being carried out due to the information having to be sent and received mutually between the user and the contents provider, the telephone line is placed in a busy state.

However, because there is a limit on the telephone lines allocated to each base station in the radio area of each base station, if the radio circuits are in a state of use for an extended period of time because of the tasks needed to be performed for the contents acquisition as described above, then it becomes difficult to allocate radio circuits to other users. In particular, if access becomes concentrated such as when users are acquiring popular contents, then the radio traffic increases and in some cases, even if other users wish to use a radio circuit for telephone communication, the system lapses into a state in which it is difficult for a radio circuit to be allocated.

Thus, in the conventional contents delivery method, the problem has arisen that, because of the increase in radio traffic, it has not been possible to meet the demands of users.

The present invention was conceived of in view of the above circumstances and it is an object thereof to provide an information delivery system and an information delivery method that avoid any increase in radio traffic and meet user demands by delivering information to a user terminal only when there are radio resources that are available for use.

### SUMMARY OF THE INVENTION

In order to achieve the above object, the present invention comprises: available radio resources determination means for determining whether or not available radio resources are present in each zone where radio communication is performed; an information database in which information to be delivered to a user terminal is stored; and information delivery means for delivering information stored in the information database to a user terminal located within the relevant zone when a zone having available radio resources is detected by the available radio resources determination means.

By delivering information to a user terminal located in a particular zone using available radio resources, it is possible to deliver information while avoiding any increase in radio traffic.

Moreover, the present invention comprises: available radio resources determination means for determining whether or not available radio resources are present in each zone where radio communication is performed; a customer database in which information and also information relating to a user who receives this information are matched together and stored; identification means for identifying a user terminal located within the relevant zone when a zone having available radio resources is detected by the available radio resources determination means; and information delivery means for acquiring from the customer database information matched with a user terminal identified by the identification means and stored and then delivering the acquired information to the relevant user terminal.

Moreover, in the above described information delivery system, for each zone or predetermined area comprising at least one zone, information belonging to that zone or area is stored in the information database, and when a zone having available radio resources is detected by the available radio resources determination means, the information delivery means acquires the information belonging to that zone which is stored in the information database and delivers the information to a user terminal that is located within that zone.

Moreover, in the above described information delivery system, the information delivery means sets in advance an order of priority for information to be delivered and also possesses a delivery history and, when delivering the information, delivers the information based on the order of priority or the delivery history.

Moreover, in the above described information delivery system, there is provided charge information accumulation means for accumulating charge information in accordance with a length of delivery time or an amount of information delivered when information is delivered to the user terminal.

Moreover, in the above described information delivery system, it is possible for the user terminal to be set up such that the user is notified when available memory capacity has reached zero or near to zero or to be set up such that storage memory areas where old information is stored are overwritten by new information.

Moreover, in the above described information delivery system, attributes of information to be received are able to be set in the user terminal. Moreover, in the above described information delivery system, the user terminal is provided with a function according to which, when information that has already been received is received again, one of the duplicated information items is deleted.

Moreover, in the present invention a determination is made as to whether or not available radio resources are present in each zone where radio communication is performed and when a zone having available radio resources is detected, information is delivered to user terminals located within that zone.

Note that the above outline of the invention does not intended to list all the features requisite to the present invention and various sub-combinations of the above feature groups are also covered by the scope of this application.

### BRIEF DESCRIPTION OF THE DRAWINGS

FIG. 1 is a view of the basic system structure of the information delivery system of the present invention.

FIG. 2 is a view of the system structure of the information delivery system according to the first embodiment of the present invention.

FIG. 3 is a view of the system structure of the information delivery system according to the second embodiment of the present invention.

FIG. 4 is an example of another system structure of the information delivery system according to the first embodiment of the present invention.

### DESCRIPTION OF THE PREFERRED EMBODIMENTS

An embodiment of the present invention will now be described with reference made to the drawings.

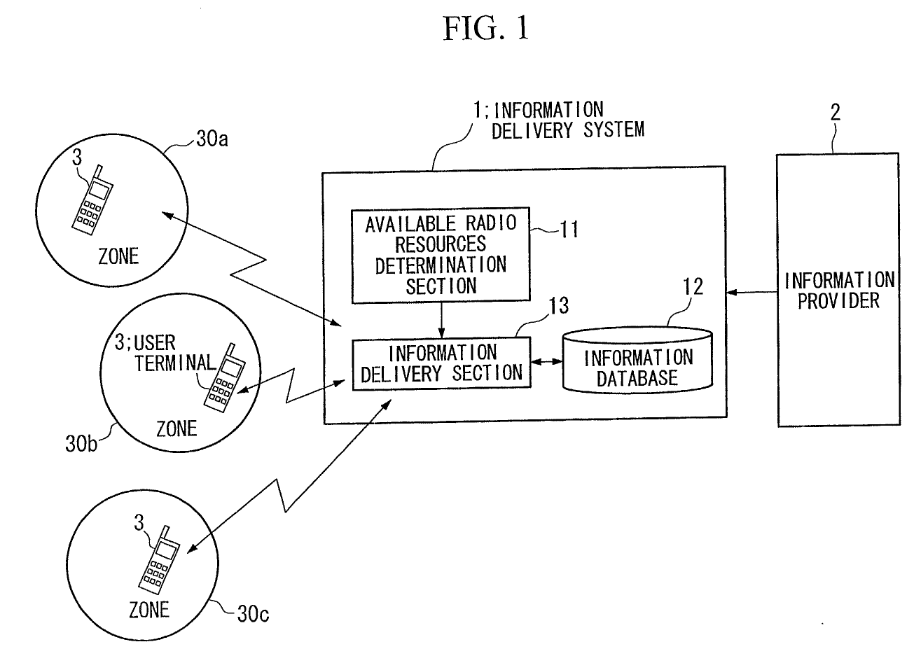

FIG. 1 is a view of the basic system structure of the information delivery system of the present invention.

In FIG. 1, reference numeral 1 indicates the information delivery system, 2 indicates the information provider, while 3 indicates the user terminal.

In the information delivery system 1, reference numeral 11 indicates an available radio resources determination section for determining the existence or otherwise of available radio resources in each of the zones 30a, 30b, and 30c, etc in which radio communication is carried out. Reference numeral 12 indicates an information database in which information acquired from the information provider 2 is stored. Reference numeral 13 indicates an information delivery section for delivering information stored in the information database 12 to the user terminal 3 located within a zone which has been detected by the available radio resource determination section 11 as being one which has available radio resources. Here, the zones 30a, 30b, 30c, etc correspond to the radio areas of each base station used in the radio communication.

The information provider 2 is an information provider such as an advertising agency or contents provider and the user terminal 3 is a mobile communication terminal capable of being carried by a person such as a PDC or PHS device that allows communication using a radio circuit.

Next, a brief description will be given of the operation of the above information delivery system 1.

The available radio resource determination section 11 acquires information from each base station and determines from this information whether or not there are available radio resources present in the radio area of each base station. If it is determined that there are available radio resources present, information about the zone in which the available radio resources are present is provided to the information delivery section 13. When the information delivery section 13 acquires the information of the zone in which the available radio resources are present, by sending information stored in the database 12 to the base station of the zone in which the available radio resources are present, it delivers the information via the base station to a user terminal 3 located in the zone, namely, in the radio area of the base station. Because the information delivery system 1 delivers information provided by the information provider 2 to the user terminal 3 using available radio resources in this way, it is possible to deliver information to the user terminal without causing any increase in the radio traffic.

Next, a description will be given of the determination as to the existence or otherwise of available radio resources made by the available radio resources determination section 11.

Normally, the maximum number of lines capable of being allocated within the radio area (i.e. within the zone) of each base station is fixed. The maximum number of lines is a fixed value determined by the radio format and frequency band that are used. The available radio resources determination section 1 determines that radio resources are available when the number of lines remaining once the number of lines Cnow already allocated has been subtracted from the maximum number of lines Cmax is greater than the number of lines Cre that need to be secured. This can be expressed as the following formula:

Cmax−Cre>Cnow (1)

In zones where the above formula is valid, it is determined that there are available radio resources present and notification of this conclusion is made to the information delivery section 13.

However, in the above Formula (1), the number of lines Cre that need to be secured differs depending on the capacity transition state. Namely, because the frequency of line use differs between urban and rural areas, the value of the number of lines Cre that need to be secured also differs. The value also differs depending on the time of a day. Namely, the number of lines Cre that need to be secured is set at a high value during the daytime for an urban area having a high frequency of line use. In contrast, the number of lines Cre that need to be secured is set at a low value at night for a rural area having a low frequency of line use.

When the above Formula (1) is valid, the available radio resources determination section 11 outputs the fact that available radio resources are present to the information delivery section 13 after considering the changes in the Cre arising from the location and time of day.

A description will be given next of the user terminal 3.

The user terminal 3 is provided with an attribute setting function for selecting attributes of information received and it is possible to set in advance information that the user does not wish to receive. As a result, if information that has been set as information the user does not wish to receive is delivered to the user terminal 3, the user terminal automatically eliminates that information.

The user terminal 3 is also provided with a function for making settings as to whether or not received information is to be automatically stored in memory (not illustrated). Here, if the selection to automatically store information in memory is made by the user, the user terminal stores the received information as it is received. As a result, it is possible for the user to confirm information at a time of the user's reading by choosing it from the storage section and displaying it on the display section. In addition, information not needed by the user can be eliminated at the user's discretion.

In contrast, if the selection is made by the user not to automatically store the information in memory, each time the user terminal receives information or when a predetermined number of items of information have been received, the fact that this information has been received is notified to the user and a decision of whether to save or not is sought from the user for each item of information. Thereafter, only that information that has been selected for saving by the user is saved in memory.

Moreover, the user terminal 3 is also provided with a function of being able to be set such that the user is notified when the available memory capacity has reached zero or near to zero of this fact by means of an alarm or the like or to be set such that the storage memory areas where old information is stored are overwritten by new information. In addition, if information is received while the memory capacity is zero or near zero, the user terminal 3 stores that information based on data set in advance by the user.

The user terminal 3 is also provided with a filter so as not to receive again information that has already been received once in order to avoid the duplicate reception of information.

### First Embodiment

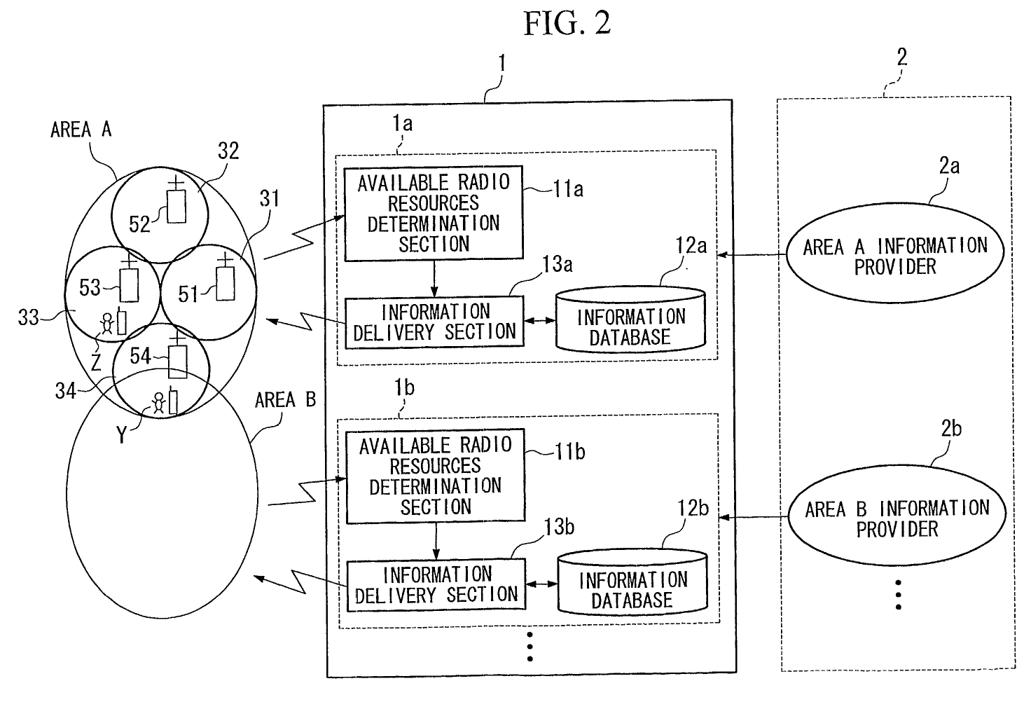

Next, a detailed description will be given using FIG. 2 of the information delivery system of the first embodiment of the present invention.

In FIG. 2, reference numeral 51 to 54 indicate base stations while reference numeral 31 to 34 indicate the radio areas, namely, zones of the respective base stations 51 to 54. In addition, area A and area B indicate areas larger than the zones such as a city, town or village or a city ward. Here, the zones 31 to 34 are contained in area A while zone 34 is contained in both area A and area B. Note that these areas are not limited to a city, town or village or a city ward and may be set optionally to any area.

In the present embodiment, information delivery devices 1a, 1b, etc each comprising an available radio resources determination section, an information database, and an information delivery section are provided in the information delivery system 1 so as to correspond to the above described areas. The area A information delivery device 1a provided so as to correspond to area A will be taken as an example. By acquiring information relating to the radio resources from the base stations 51 to 54, the available radio resources determination section 11a determines the available radio resources of each zone 31 to 34 in area A.

Information belonging to area A, for example, information concerning events held in area A, information concerning department stores or small shops in area A provided by the information provider 2a of area A is stored in the information database 12a. When information about a zone in which available radio resources have been detected by the available radio resource determination section 11a is acquired, the information delivery section 13a sends information belonging to area A stored in the information database 12a to the base station of the relevant zone. As a result, information belonging to area A is automatically delivered to a user terminal located within the zone.

A detailed description will now be given of the operation of the information delivery system when available radio resources are present in zones 33 and 34.

In this case, the available radio resources determination section 11a in the information delivery device 1a of area A detects that available radio resources are present in zones 33 and 34 and notifies the information delivery section 13a of that fact. As a result, the information delivery section 13a acquires information from the information database 12a and sends this information to the base station 53 of the zone 33 and the base station 54 of the zone 34. This results in information belonging to area A being delivered in succession to the user terminal 3 of the user Z in zone 33 and the user terminal 3 of the user Y in zone 34.

In the same way, the available radio resources determination section 11b in the information delivery device 1b of area B also detects that available radio resources are present in zone 34 and notifies the information delivery section 13b of that fact. As a result, the information delivery section 13b acquires information belonging to area B stored in the information database 12b and sends this information to the base station 54 of the zone 34. This results in information belonging to area B being delivered in succession to the user terminal 3 of the user Y in zone 34.

As a result, information belonging to area A is delivered automatically to the user terminal 3 of user Z in zone 33 while information belonging to area A and area B is delivered to the user terminal 3 of user Y in zone 34 where area A and area B overlap.

In this manner, information belonging to an area containing a zone in which available radio resources are determined to be present by the available radio resources determination section is successively delivered from the information delivery section to user terminals present in that zone. Moreover, in a zone in which two or more areas overlap, information belonging to each area is delivered from the information delivery device of that area.

Note that, at the time the information is delivered, the information delivery sections 13a, 13b, etc deliver information beginning with information that has been delivered the fewest number of times and is also information having a high order of priority. The order of priority is set in advance for information stored in the information database and at the time of the delivery, the information delivery section 13 delivers the information based on this order of priority and on the delivery history of information hitherto delivered. For example, information is delivered beginning first with the item of information that has the highest order of priority from among the items of information having the least delivery history. As a result, it is possible for information to be delivered equally.

Note that it is also possible for the information to be delivered based on just one of the above described number of deliveries and order of priority.

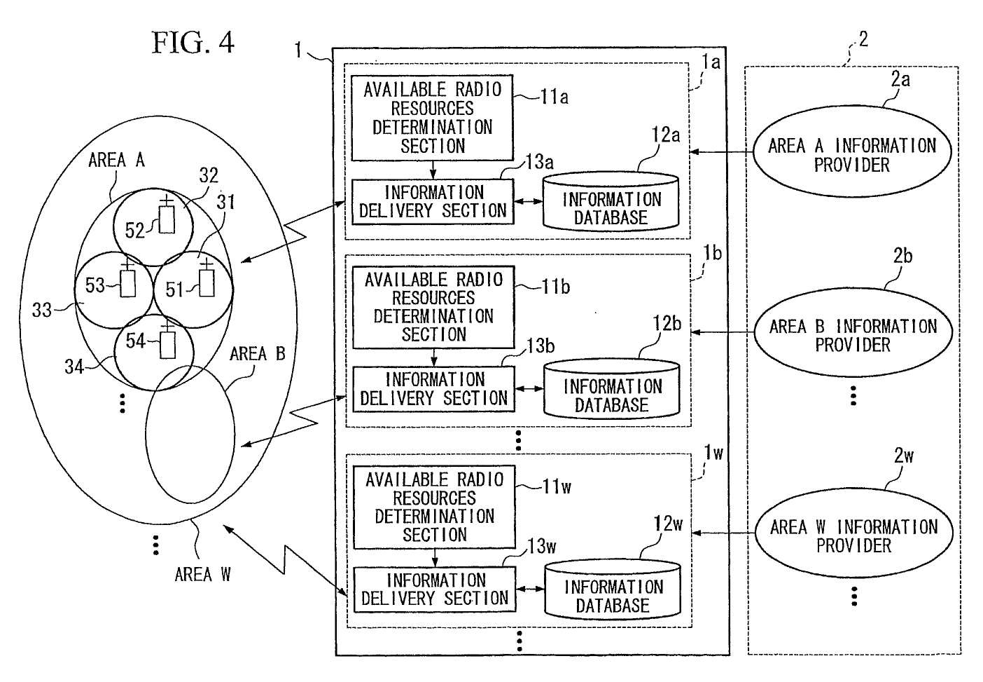

Furthermore, in the present embodiment, the information delivery system 1 is formed from information delivery devices 1a, 1b, etc that correspond to each area (area A, area B, etc), however, as is shown in FIG. 4, it is also possible to further provide an information delivery device 1w that corresponds to an area that includes each of the above areas and also covers a greater area than the above areas.

For example, if area A and area B shown in FIG. 4 are taken as corresponding to the respective wards in Tokyo City, an information delivery device 1w is further provided to correspond to Tokyo City, for example, an area W that is larger in areas than the respective wards. In addition, the information belonging to each ward is stored in the information databases 12a and 12b of the respective information delivery devices 1a and 1b provided to correspond to each ward, while information belonging to Tokyo City, for example, the weather for Tokyo, traffic information concerning Tokyo, information about the metropolitan government, and the like is stored in the information database 12w of the information delivery device 1w provided to correspond to Tokyo City.

Moreover, if a zone in which available radio resources are present is detected in Tokyo City which is covered by the information delivery device 1w, the information delivery section 13w of the information delivery device 1w acquires information belonging to Tokyo City by accessing the information database 12w and sends the information to the base station of the zone in which the available radio resources were detected. In the same way, the information delivery devices provided to correspond to the wards in which the zones with the detected available radio resources are present also acquire information belonging to the relevant ward from the information database and send the information to the base station of the relevant zone.

As a result, the user terminal is able to acquire a wide range of information ranging from information from a wide area concerning Tokyo City to information from a small area localized for a particular ward.

In this way, when a plurality of information delivery devices are provided in which information belonging to the areas covered by the respective devices is stored and zones in which available radio resources are present are detected in the covered areas, information belonging to the areas is delivered to user terminals present within the zone. The result of this is that the user terminal is able to acquire a wide range of information from information of a wide area to information of a small area. Note that information stored in the information database of each information delivery device is more localized for each area that is covered by the information delivery device the smaller that area is. In addition, it is preferable if the items of information stored in the respective information databases are not duplicates of each other.

### Second Embodiment

Next, a description will be given of the information delivery system according to the second embodiment of the present invention.

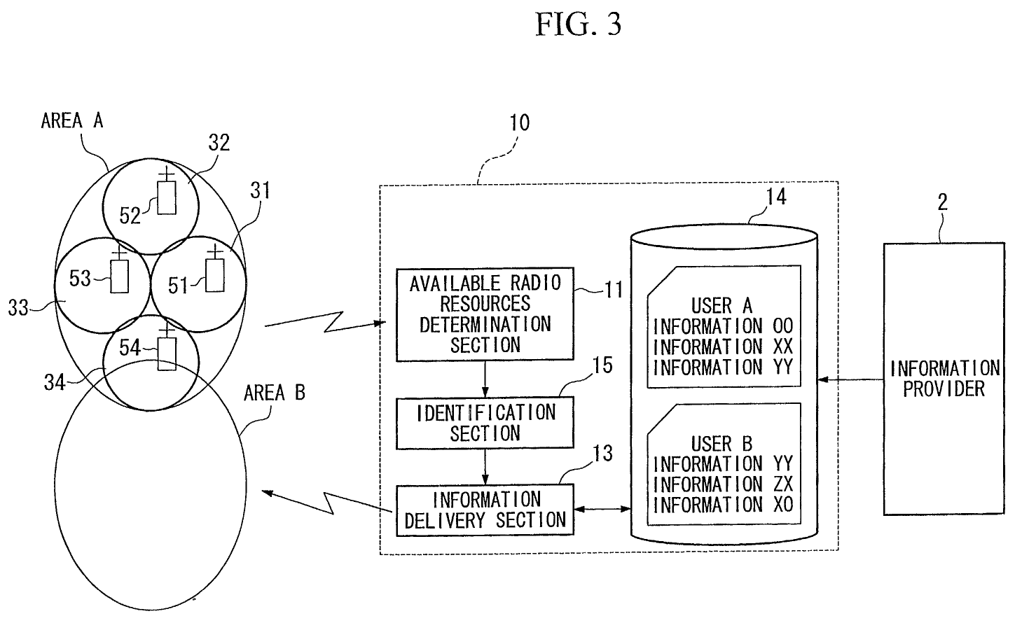

In the above described information delivery system according to the first embodiment, information is delivered to all of the user terminals located within a zone in which available radio resources are present, namely, to an undetermined number of user terminals. However, in the second embodiment, information whose delivery is desired by the user is provided to a user terminal registered in this system. The second embodiment of the present invention is described below in detail with reference made to FIG. 3.

FIG. 3 shows the structure of the information delivery system according to the second embodiment. In FIG. 3, the same elements as those in the structure shown in FIG. 1 are given the same descriptive symbols and a description thereof is omitted.

As shown in FIG. 3, in the second embodiment, a customer database 14 is provided instead of the information database 12 shown in FIG. 1 and an identification section 15 for identifying a user terminal is additionally provided. In the customer database 14, user terminal information and information to be delivered to the user terminal are matched together and stored.

In the information delivery system having the above structure, when a zone in which available radio resources are present is detected by the available radio resources determination section 11, the information of the zone in which the available radio resources are present is output to the identification section 15. When the identification section 15 receives this information, it identifies user terminals located within the zone and outputs information of the identified user terminals to the information delivery section 13. The information delivery section 13 acquires from the customer database 14 the information that has been matched with the user terminal information input from the identification section 15 and stored, and then delivers the acquired items of information to the respective user terminals.

As a result, a user who is located within a zone in which available radio resources are present is able to automatically acquire information whose delivery he or she has requested.

Note that if the number of times information has been delivered to each user terminal or the length of time needed to deliver the information is stored for each user terminal, and the system is set such that, at the time of the information delivery, information is delivered beginning with the user terminal having the fewest number of deliveries or having the shortest time needed to deliver the information, then it is possible to deliver the information to all users as equally as possible.

Furthermore, in the present embodiment, as will be understood from FIG. 3, as regards the data stored in the customer database 14, in each user terminal the information to be sent to that user terminal has been enumerated and formed as files, however, instead of this, for each item of delivered information, it is also possible to form files with the information of the user terminals receiving the information delivery enumerated. In this case, for example, a delivery priority ranking is allocated to each item of information stored in the customer database 14 and the number of times each item of information has been delivered is stored. Consequently, when information is delivered, it is delivered beginning with information that has only been delivered a few number of times and also has a high order of priority to a user terminal that has been matched to this information and is located within a zone in which it has been determined by the available radio resources determination section 11 that available radio resources are present.

Furthermore, by setting up the user terminal in advance such that information that the user has asked not to receive is not received, if information is delivered without the user terminals being identified, it is possible to arrange for information to be received only by the user terminal of a user who has asked for that information to be delivered. As a result, the need in the information delivery system for the user terminal to which information is delivered to be identified no longer exists, which means that the identification section 15 does not need to be provided enabling the system structure to be simplified and the cost thereof to be lowered.

Note that it is also possible for a database of charges to be added to the information delivery systems 1 and 10 in the above described first and second embodiments and to pay a fee to the information provider in accordance with the length of the delivery time or the amount of information pertaining to the delivery. Specifically, by recording the history of the delivered information as well as the amount of information or the time needed for the delivery thereof in each user terminal and adding up after predetermined periods the amount of information delivered or the delivery time of each item of information in each user terminal, a payment corresponding to the result of the adding up can be made to the information provider. If a charge system such as this is introduced, it is possible to acquire information from a greater number of information providers and provide more depth to the delivered information. In addition to this, in the above described information delivery system, instead of delivering the information acquired from an information provider to a user terminal free of charge by direct mail or the like, it is also possible for an advertising fee to be received from each information provider.

As a result, the information delivery system can obtain income from advertising fees from the information providers and income from the amount of received information from the users of mobile terminals.

It should be noted that the embodiments described above are simply examples used to explain the present invention. The present invention is in no way limited by the above embodiments and different variations may be possible within the range of the aims of the present invention.

As has been described above, according to the information delivery system of the present invention, because information is delivered to a user terminal located within a zone having available radio resources, it is possible to deliver information without causing an increase in the radio traffic which results in a user always being able to easily receive information. In addition, by avoiding any increase in the radio traffic, the effect of being able to constantly provide a service that matches the needs of the user is obtained.

Furthermore, because, for each zone or predetermined area comprising at least one zone, information belonging to that zone or area is stored in the information database, and because, when a zone having available radio resources is detected by the available radio resources determination means, the information delivery means acquires the information belonging to that zone which is stored in the information database and delivers the acquired information to a user terminal that is present within that zone, the effect is obtained that the user is able to easily acquire information concentrated on the area in which the user is located.

Moreover, because the information delivery means sets in advance an order of priority for the information to be delivered and also possesses a delivery history and when delivering the information delivers it based on the order of priority and the delivery history, the effect is obtained that it is possible to deliver the information stored in the information database equally and with a fine degree of balance.

Moreover, because there is provided charge information accumulation means for accumulating charge information in accordance with the length of delivery time or the amount of information delivered when information is delivered to a user terminal, the effect is obtained that it is possible to acquire information from a greater number of information providers and provide more depth to the delivered information.

Furthermore, because there are provided: available radio resources determination means for determining the existence or otherwise of available radio resources in each zone where radio communication is performed; a customer database in which information and also information of the user terminal which receives this information are matched together and stored; identification means for identifying a user terminal located within the relevant zone when a zone having available radio resources is detected by the available radio resources determination means; and information delivery means for acquiring from the customer database information matched with a user terminal identified by the identification means and stored and then delivering the acquired information to the relevant user terminal, the effect is obtained that it is possible for only the information that the user wishes to receive to be delivered and for a service that more closely meets the demands of the user to be provided.

Moreover, it is possible for the user terminal to be set up such that the user is notified when the available memory capacity has reached zero or near to zero of this fact or to be set up such that the storage memory areas where old information is stored are overwritten by new information. In addition, because attributes of the information to be received are able to be set in the user terminal, the user is able to view specific information of a particular area at the time of his or her choosing.

As a result, the effect is obtained that a variety of settings can be made depending on the wishes of the user and a flexible service can be provided that responds to the needs of each individual user.

What is claimed is:

1. An information delivery system comprising:
available radio resources determination device which determines whether or not available radio resources are present in each zone where radio communication is performed;
an information database in which information to be delivered to a user terminal is stored; and
information delivery device which delivers information stored in the information database to a user terminal located within the relevant zone when a zone having available radio resources is detected by the available radio resources determination means.

2. An information delivery system comprising:
available radio resources determination device which determines whether or not available radio resources are present in each zone where radio communication is performed;
a customer database in which information and also information relating to a user which receives this information are matched together and stored;
identification device which identifies a user terminal located within the relevant zone when a zone having available radio resources is detected by the available radio resources determination means; and
information delivery device which acquires from the customer database information matched with a user terminal identified by the identification means and stored and then delivering the acquired information to the relevant user terminal. 19

3. The information delivery system according to claim 1 or 2, wherein, for each zone or predetermined area comprising at least one zone, information belonging to that zone or area is stored in the information database, and when a zone having available radio resources is detected by the available radio resources determination means, the information delivery means acquires the information belonging to that zone which is stored in the information database and delivers the information to a user terminal that is located within that zone.

4. The information delivery system according to claim 1 or 2, wherein the information delivery device which sets in advance an order of priority for information to be delivered and also possesses a delivery history and, when delivering the information, delivers the information based on the order of priority or the delivery history.

5. The information delivery system according to claim I or 2, wherein there is provided charge information accumulation device which accumulates charge information in accordance with a length of delivery time or an amount of information delivered when information is delivered to the user terminal.

6. The information delivery system according to claim 1 or 2, wherein it is possible for the user terminal to be set up such that the user is notified when available memory capacity has reached zero or near to zero or to be set up such that storage memory areas where old information is stored are overwritten by new information.

7. The information delivery system according to claim 1 or 2, wherein attributes of information to be received are able to be set in the user terminal.

8. The information delivery system according to claim 1 or 2, wherein the user terminal is provided with a function according to which, when information that has already been received is received again, one of the duplicated information items is deleted.

9. An information delivery method in which a determination is made as to whether or not available radio resources are present in each zone where radio communication is performed and when a zone having available radio resources is detected, information is delivered to user terminals located within that zone.
